(19) United States
(12) Patent Application Publication
(10) Pub. No.: US 2004/0169847 A1
(43) Pub. Date: Sep. 2, 2004

(54) Method for marking articles to allow their authentification

(75) Inventor: Shlomo Dukler, Tel Aviv (IL)

Correspondence Address: BROWDY AND NEIMARK, P.L.L.C., 624 NINTH STREET, NW, SUITE 300, WASHINGTON, DC, 20001-5303, US

(73) Assignee: InkSure Inc., New York, NY

(21) Appl. No.: 10/787,105

(22) Filed: Feb. 27, 2004

Related U.S. Application Data
(60) Provisional application No. 60/449,831, filed on Feb. 27, 2003.
(60) Provisional application No. 60/470,424, filed on May 15, 2003.

(51) Int. Cl. G06K 9/74

(52) U.S. Cl. 356/71

(57) ABSTRACT

The present invention provides novel methods for marking, authenticating and identifying articles that make use of photoluminescent materials, as well as articles marked by these methods.

An articled marked according to the present invention has a unique sequence of patterns, including invisible photoluminescent patterns, wherein each pattern has a position in the sequence, and each invisible photoluminescent pattern is characterized by an excitation wavelength, an emission wavelength, and a time delay, and at least two of said photoluminescent patterns have mutually different excitation wavelengths or time delays.

### FIELD OF THE INVENTION

The present invention relates to methods for marking, authenticating and identifying articles that make use of photoluminescent materials, and to articles marked by the marking method of the invention.

### BACKGROUND OF THE INVENTION

The idea to mark articles in order to allow their authentication and identification is heavily used. For example, documents are marked with watermarks, checks are marked with magnetic print, banknotes are marked with microprinting, etc.

Among these methods there are also methods known in the art for marking articles with fluorescent materials, for example the method described in WO 87/06197, which describes an article comprising a substrate having markings which are provided by at least two visible fluorescent materials which have different excitation spectra in the UV region of the spectrum and different emission spectra in the visible region of the spectrum.

EP 0 889 446 describes a document recognition apparatus for banknotes, which utilizes barcodes which are printed in fluorescent ink on the surface of the banknotes.

WO89/00319 describes a method for marking of banknotes with a coating which is invisible to the naked eye under normal lighting. The coating consists of a colorless polymer solution mixed with fluorescent substances.

U.S. Pat. No. 5,990,197 describes an organic solvent based polyester ink formulation having a fluorescing compound, which is said to be suitable for ink jet printing applications. The ink is described to be useful for producing invisible markings on the surface of a variety of materials for identification, authentication, sorting, etc. The document describes several inks with excitation and emission wavelength that are both out of the visible range.

Glosary

The following terms will be used throughout the description and claims and should be understood in accordance with the invention to mean as follows:

Photoluminescent material—a material that emits light of a certain wavelength upon being irradiated with light of another wavelength. Usually the light emission continues as long as the light irradiation continues, however, in some photoluminescent materials, the emission continues for a certain time after the irradiation with the excitation wavelength stops. This certain time is referred to herein as a time delay. Photoluminescent material typically comprises a photoluminescent compound together with additional constituents such as adhesives, solvents, carriers, and the like. Photoluminescent materials include fluorescent materials and phosphorescent materials, but are not necessarily restricted thereto.

Excitation wavelength—wavelength of light that should be irradiated on a photoluminescent material in order to induce light emission.

Emission wavelength—wavelength of light emitted by a photoluminescent material upon being irradiated with light having an excitation wavelength.

Time delay—a time period in which light is emitted from a photoluminescent material after the irradiation of light of the excitation wavelength has stopped. The time delay may also be defined as the time between the end of irradiation of light having an excitation wavelength and the decay of the emitted light to half (or any other predetermined portion) of the value it had in the presence of irradiation of light having an excitation wavelength.

Invisible—not detectable to the human eye when irradiated with white light of a regularly used sort, such as sunlight, incandescent lamp, a fluorescent lamp, etc. However, an invisible feature may be detectable to the human eye when irradiated with UV light alone. Preferably, invisible features according to the present invention are not detectable to the human eye under any lighting conditions, as the excitation wavelength and the emission wavelength of the photoluminescent materials associated therewith are the same as that of their background, or are out of the visible range.

Series—a group of at least two members, the series being identified by the identity of the members.

Sequence—a kind of series, where each member has a position, and the sequence is characterized by the identity of the members and by their relative order in the sequence.

### SUMMARY OF THE INVENTION

The present invention provides novel methods for marking, authenticating and identifying articles that make use of photoluminescent materials, as well as articles marked by these methods.

According to one aspect of the present invention there is provided a method for marking an article with invisible marks to allow its identification or authentication by means suitable to read such marks.

The marking method of the invention comprises applying to the article a unique sequence of patterns, including invisible photoluminescent patterns, wherein each pattern has a position in the sequence, and each invisible photoluminescent pattern is characterized by at least one excitation wavelength, at least one emission wavelength, and at least one time delay, and at least two of said excitation wavelength or time delays are mutually different.

According to one embodiment of the invention the unique sequence of patterns include invisible photoluminescent patterns that overlap each other. In such a case, the overlapping patterns appear as a single pattern, having several photoluminescent materials. Preferably, the photoluminescent materials react separately to light, such that a first exciting wavelength excites a first material to emit light of a first emission wavelength, and a second exciting wavelength excites a second material to emit light of a second emission wavelength. In this embodiment various exciting light beams should be directed to the same position in order to produce a variety of light emissions.

A method according to the invention may use only the excitation and emission wavelengths, ignoring time delays, or it may use only time delays, ignoring emission wavelengths, or it may make use both excitation and emission wavelength and time delays.

Methods of the invention may be used for identification and authentication of any object, such as bus or train tickets, telephone cards, banknotes, checks, passports, ID cards, and security documents. These methods may also be useful for brand protection.

A pattern according to the invention may have any shape from dot to complex fractal structure. Preferable are patterns of simple geometric shapes such as squares, rectangles, triangles, and circles.

According to another aspect of the present invention there is provided an authentication method, for authenticating an article that was marked according to the marking method of the invention with a unique sequence as defined above.

The authentication method of the invention comprises:

(a) providing an authentication sequence including members, each of which is characterized by its position in the sequence, at least one excitation wavelength, at least one emission wavelength and at least one time delay, wherein at least two of said excitation wavelengths or at least two of said time delays are mutually different;

(b) irradiating each of the invisible photoluminescent patterns included in the unique sequence marked on said article with a light beam having a wavelength identical to the excitation wavelength characterizing a member in the authentication sequence, the position of which in said authentication sequence corresponds to the position of the irradiated invisible photoluminescent pattern in the unique sequence;

(c) detecting wavelengths of light emitted by each of said invisible photoluminescent patterns, to obtain a sequence of emission wavelengths and/or time delays; and

(d) comparing the sequence of emission wavelengths and/or time delays obtained in (c) with the emission wavelengths and/or time delays of the authentication sequence provided in (a) to determine if the article is authentic or not.

In one embodiment of the invention it is determined that the article is authentic if the sequences are identical and not authentic otherwise. The patterns may have mutually different positions, or at least some of them may overlap with others. In one embodiment of the invention all the patterns overlap, such that all the exciting wavelengths are irradiated towards the same pattern.

In one embodiment of the invention, time delays are ignored, such that the authentication sequence provided in (a) includes only excitation and emission wavelengths, the detection at (c) is only of emission wavelengths, and so is the comparison of (d).

According to another embodiment of the present invention only time delays are used, such that the authentication sequence provided in (a) includes only time delays, and this is the only measured piece of data compared in (d).

According to yet another embodiment of the present invention both emission wavelengths and time delays are provided in (a) and compared in (d).

Whether ignored data is measured in (c) or not is immaterial to the present invention.

A similar method can be used to identify an article, wherein in (a) a plurality of authentication sequences are provided, each associated with a certain article identity, and (b) to (d) are carried out several times, each time with another of the authentication sequences until an authentication sequence that corresponds to the distinguishing sequence of the article is encountered, and the article is identified to have the identity associated therewith. If the distinguishing sequence does not correspond to any of the authentication sequences provided in (a) it is to be concluded that the article is not authentic.

Naturally, the method may be also carried out such that first every pattern is checked for its interaction with a plurality of lights, each corresponding to the same position in a plurality of authentication sequences, and only then the next pattern is irradiated. Such a method may have the advantage of requiring a minimal number of movements of the beam of exciting light from one pattern to another.

The members of the authentication and unique sequences according to the present invention may be characterized by their excitation and emission wavelengths, by their time delays, and also by further characteristics, such as the intensity of the emitted light.

The methods of the invention may utilize patterns of non-luminescent character (i.e. which are not excitable to emit light). Such non-luminescent patterns, when they are not the first or the last in the sequence, may be also described as spaces between luminescent patterns.

According to another aspect of the present invention there is provided an article having marked thereon a unique sequence of patterns, including at least two invisible photoluminescent patterns, wherein each pattern has a position in the sequence, and each photoluminescent pattern is characterized by at least one excitation wavelength, at least one emission wavelength, and at least one time delay, and at least two of said photoluminescent patterns have mutually different emission wavelengths and/or mutually different time delays.

The patterns may have mutually different positions, or at least some of them may overlap with others. In one embodiment of the invention all the patterns overlap, such that the entire sequence of exciting wavelengths is irradiated towards the same pattern. The unique sequence always includes at least two invisible photoluminescent patterns, but may also include visible patterns, which may be photoluminescent or not, and non-luminescent patterns, which may be visible or not.

According to the invention, the photoluminescent patterns are marked on the article by means of photoluminescent materials that may be the same or different. If the two patterns are marked by the same material, this material must have at least two different excitation wavelengths, that upon irradiation with each of them the material emits light of an emission wavelength, or at least two time delays, each for an emission wavelength of its own.

According to the present invention the patterns may be marked anywhere on the product, but preferably they are adjacent to each other to compose a string of markings.

Typically, the markings are printed on the article.

### BRIEF DESCRIPTION OF THE DRAWINGS

In order to understand the invention and to see how it may be carried out in practice, a detailed description of some specific embodiments will now be given, by way of non-limiting example only, with reference to the accompanying drawings, in which:

FIG. 1 is an illustration of a banknote marked according to the present invention.

FIG. 2 is an illustration of a shirt label marked according to the present invention.

FIG. 3 is an illustration of an identifying tag marked with overlapping patterns according to the present invention.

FIG. 4 is an illustration of a painting marked with both non-overlapping and overlapping patterns according to the present invention.

### DETAILED DESCRIPTION OF THE INVENTION

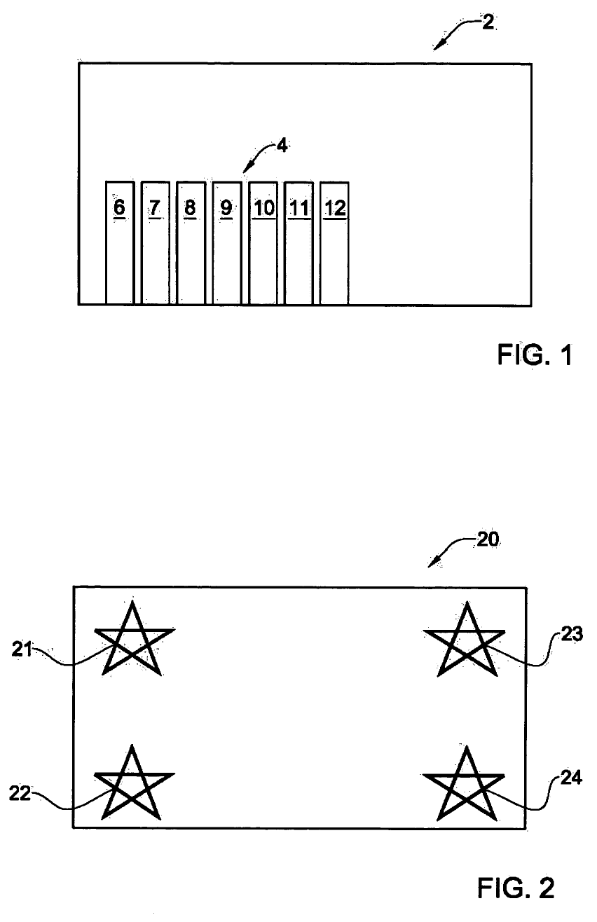

FIG. 1 shows a banknote 2 that was marked according to the marking method of the invention. Marked thereon is a unique sequence 4 of patterns 6 to 12, each having a shape of a rectangular strip, creating together a string of patterns. The reference numerals 6-12 correspond to the position of the patterns in the unique sequence 4, such that pattern 6 is in the 1^{st} position in the sequence, pattern 7 in the 2^{nd}, etc. The patterns 6 to 12 are not detectable to the human eye on the background of the banknote under any type of lighting, and are drawn in the pattern as a noticeable feature only for purpose of illustration.

The patterns 6 to 12 include invisible photoluminescent patterns 6-8, 10, and 12, and non-photoluminescent patterns 9 and 11. Each of the invisible photoluminescent patterns 6-8, 10, and 12, is marked with a material, and Table II lists the serial numbers of these materials in Table I. It may be seen in the Tables that at least patterns 6 and 8 have mutually different emission wavelengths. Table II supplies, apart of the characteristic positions and wavelengths of the patterns 6-12 also references to commercially available photoluminescent materials that allow such markings, and manufacturers thereof. Preparation of inks from the listed materials is known to a person skilled in the art of producing inks. Patterns 9 and 11 are of non-luminescent character (i.e. are not excitable to emit light). Such non-luminescent patterns may be also used according to the present invention, and when they are not the first or the last in the sequence, may be also described as spaces between photoluminescent patterns.

TABLE I

| Serial | Photoluminescent | Excitation | Emission | |
|---|---|---|---|---|
| no. | material | wavelength | wavelength | Firm |
| 1 | PHOSPHOR PTIR 475 | 980 | 480 | Phosphor UK |
| 2 | PHOSPHOR PTIR 545 | 980 | 545 | Phosphor UK |
| 3 | PHOSPHOR PTIR 550 | 980 | 550 | Phosphor UK |
| 4 | PHOSPHOR PTIR 660 | 980 | 683 | Phosphor UK |
| 5 | Sterling U.V Blue 70 (325 | 370 | 450 | Aldrich |
| | Series) | | | |
| 6 | 8-Hydroxyquinoline, | 470 | 550 | Aldrich |
| | aluminum salt | | | |
| 7 | Acridin Orange | 370 | 440, 550, 600 | Aldrich |
| 8 | LUMILUX GRUN CD 333 | 260-400 | 490-560 | Honeywell |
| 9 | LUMILUX BLAU CD 307 | 250-270, 340-400 | 420-480 | Honeywell |
| 10 | N,N′-Ditridecyl-3,4,9,10- | 470 | 530 | Aldrich |
| | perylenetetracarboxylic | | | |
| | diimide | | | |
| 11 | 4-(Di13cyanomethylene)-2- | 470 | 560 | Aldrich |
| | methyl-6-(4- | | | |
| | dimethylaminostyryl)-4H- | | | |
| | pyran | | | |
| 12 | Nile Red | 470 | 570 | Aldrich |
| 13 | trans-4-[4- | 470 | 530 | Aldrich |
| | Dibutylamino)styryl]-1-(3- | | | |
| | sulfopropyl)pyridinium | | | |
| | hydroxide, inner salt | | | |
| | hydrate | | | |
| 14 | Lumilux CD 704 | 470 | 530 | Honeywell |
| 15 | 2,5-Bis(5-tert-butyl- | 370 | 510 | Aldrich |
| | benzoxazol-2-yl)thiophene | | | |
| | 2,5-Bis(5-tert-butyl-2- | | | |
| | benzoxazolyl)thiophene | | | |
| 16 | Rubrene | 470 | 600 | Aldrich |
| | | 370 | 550, 600 | |
| 17 | Perylene | 470 | 530 | Aldrich |
| 18 | Rose Bengal | 370 | 450, 550, 600 | Aldrich |
| 19 | 1,4-Bis(5-phenyloxazol-2- | 370 | 430 | Aldrich |
| | yl)-benzene | | | |
| 20 | Fluorescein diacetate | 370 | 400-450, 550 | Aldrich |
| 21 | Pyrene-1-carboxaldehyde | 470 | 550 | Aldrich |
| 22 | Poly(9-vinylcarbazole) | 370 | 430 | Aldrich |
| 23 | Eosin B, spirit soluble | 370, 470 | 560, 600 | Aldrich |
| 24 | 4- | 470 | 430, 550, 620 | Aldrich |
| | Dimethylaminoazobenzene- | | | |
| | 4′-sulfonyl chloride | | | |
| 25 | Ethidium bromide | 370 | 450, 550-650 | Aldrich |
| 26 | Benzo[a]pyrene | 470 | 530 | Aldrich |
| 27 | Coumarin 334 | 470 | 530 | Aldrich |

TABLE II

| | Position | | | |
|---|---|---|---|---|
| Numeral | in | Serial no. | Excitation | Emission |
| reference | sequence | in Table I | wavelength | wavelength |
| 6 | 1^{st} | 5 | 370 | 450 |
| 7 | 2^{nd} | — | — | — |
| 8 | 3^{rd} | 10 | 470 | 530 |
| 9 | 4^{th} | 21 | 470 | 550 |
| 10 | 5^{th} | 16 | 370 | 550, 600 |
| 11 | 6^{th} | — | — | — |
| 12 | 7^{th} | 16 | 370 | 550, 600 |

The first four materials listed in Table I have a time delay of several milliseconds, while the rest have negligible time delays.

FIG. 2 shows another article according to the invention. A shirt label 20 is marked in its four corners by star-shaped photoluminescent invisible patterns 21-24. As may be easily appreciated, the position in the sequence may be set arbitrarily (as it may have also been in the example of FIG. 1). Table III shows one possibility.

TABLE III

| | Position in | Serial no. | Excitation | Emission |
|---|---|---|---|---|
| Ref. Num. | sequence | in Table I | wavelength | wavelength |
| 21 | 1^{st} | 11 | 470 | 560 |
| 22 | 4^{th} | 12 | 470 | 570 |
| 23 | 3^{rd} | 15 | 370 | 510 |
| 24 | 2^{nd} | 17 | 470 | 530 |

TABLE IV

| | | |
|---|---|---|
| Position in sequence | Excitation wavelength | Emission wavelength |

| | | |
|---|---|---|
| 1 | 370 | 510 |
| 2 | — | — |
| 3 | 470 | 550 |
| 4 | 470 | 530 |
| 5 | 370 | 510 |
| 6 | — | — |
| 7 | 370 | 600 |

In order to check if the banknote illustrated in FIG. 1 and Table II is authentic or not, an authentication sequence should first be provided. One such sequence is illustrated in Table IV. According to the invention, at least two of the excitation wavelengths in the authentication sequence must be mutually different (in the example of Table IV these are at least the excitation wavelengths corresponding to positions 1 and 3).

In order to check the authentication of the banknote 2 by the authentication sequence of Table IV, one should irradiate each of the invisible photoluminescent patterns 6-12 composing the unique sequence 4 marked on the banknote 2 with a suitable wavelength in accordance with the authentication sequence of Table IV. The order of irradiation is immaterial, as long as the relations between excitation, emission, and position are known. For example, invisible photoluminescent pattern 6, being the 1^{st} pattern in the sequence 4 should be irradiated with a light beam having a wavelength of 370 nm, which is the excitation wavelength in the 1^{st} position the authentication sequence given in Table IV. Invisible photoluminescent pattern 8, being the 3^{rd} pattern in the sequence 4 should be irradiated with a light beam having a wavelength of 470 nm, which is the excitation wavelength in the 3^{rd} position in the authentication sequence given in Table IV, and so on. Except for irradiating the patterns 6-12, one should also detect light emitted thereby and analyze their wavelength to obtain a sequence of emission wavelengths. As may be noted from Table II, the sequence of emission wavelengths that may be obtained in this way from the banknote of FIG. 1, when checked against the authentication sequence of Table IV is: (450, -, 530, 550, 550 or 600, -, 550 or 600). Since this is different from the emission wavelengths of the authentication sequence of Table IV, the banknote 2 is concluded not to be authentic.

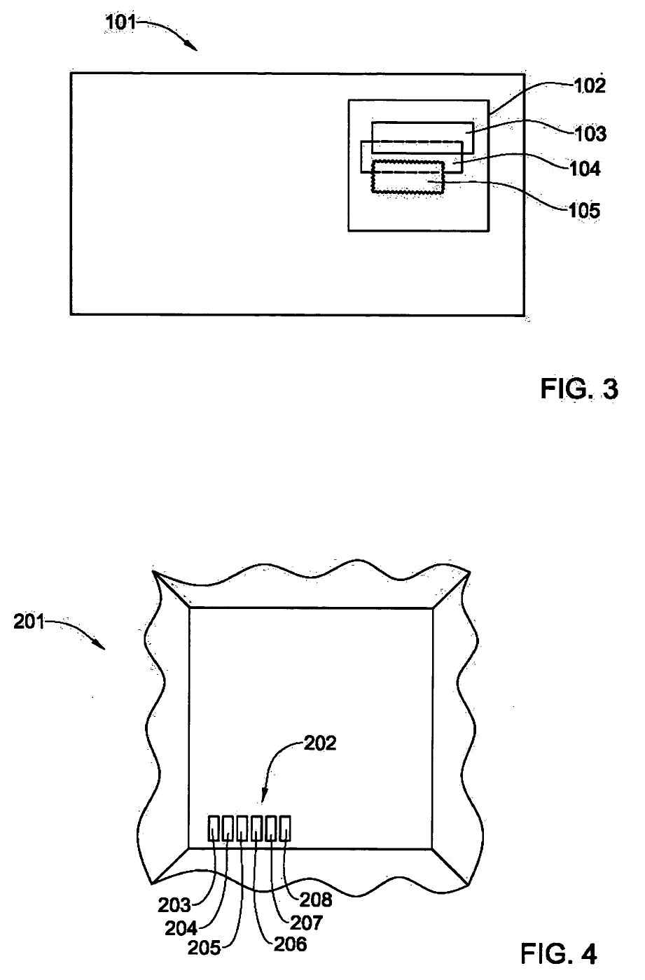

Since the authentication sequence of Table IV is nothing but a list of numbers, there is no necessity that the first excitation wavelength in this sequence will be the wavelength irradiated on the first photoluminescent pattern, or even that the first emission wavelength be that of the light emitted upon irradiation of a pattern with the first excitation wavelength. The authentication sequence may be arranged in any desirable order, as long as it is known to the user that has to decide on the authentication. FIG. 3 shows an identification tag 101 that was marked according to the marking method of the invention. On the identification tag is an identifying portion 102, whereupon are marked three overlapping invisible photoluminescent patterns 103, 104, 105, each having a shape of a rectangular strip. The patterns 103, 104, 105 are completely overlapping, but are drawn as only partially overlapping for clarity purposes. The patterns 103, 104, 105 are not detectable to the human eye on the background of the identification tag under white lighting, and are drawn in the figure as a visible rectangular shape only for purpose of illustration. The invisible photoluminescent patterns 103, 104, 105 are marked with materials from Table I. For example, pattern 103 is marked with material No. 1, pattern 104 is marked with material No. 14, and pattern 105 is marked with material No. 15, all numbers from Table I. According to the invention, at least two of the overlapping patterns should have mutually different emission wavelengths. In the embodiment of FIG. 3, all three patterns have mutually different excitation wavelengths as well as mutually different emission wavelengths.

In order to check the authentication of the identifying tag 101, the portion 102 including patterns 103, 104, 105 is irradiated with the suitable wavelengths in accordance with Table I, as provided by an authentication series. The order of irradiation is immaterial, however the expected emission wavelengths are not necessarily those provided by Table I, since the authentication series is empiric, and thus takes into account interactions between the overlapping patterns. For example, the tag 101 may be first irradiated with an exciting light beam having a wavelength of 980 nm, which is the excitation wavelength of pattern 103, and the emission wavelength expected according to Table I would be 480 nm. However, the excitation wavelength of pattern 104 is 470 nm, and it may be excited, to a certain degree by the light emitted from the pattern 103, such that the emitted wavelength of 480 nm is detected to be weaker than expected, and an emitted light of 530 nm (which is the emission wavelength of pattern 104) may be detected.

FIG. 4 is an illustration of a painting 201 that was marked for authentication and identification purposes according to the marking method of the invention. Marked thereon is a unique sequence 202 of patterns 203 to 208, each having a shape of a rectangular strip, wherein patterns 205 and 206 overlap. Patterns 205 and 206 overlap completely and are only shown as partially overlapping for the sake of clarity. Patterns 203 to 206 and 208 are marked with photoluminescent materials selected from Table I, whereas pattern 207 is non-photoluminescent. Table V lists the serial numbers of the selected materials as listed in Table I, their characteristic position in the sequence, and their excitation and emission wavelengths.

TABLE V

| | Position in | Serial No. in | Excitation | Emission |
|---|---|---|---|---|
| Ref. Num. | sequence | Table 1 | wavelength | wavelength |
| 203 | 1 | 11 | 470 | 560 |
| 204 | 2 | 4 | 980 | 683 |
| 205 | 3 | 12 | 470 | 570 |
| 206 | 3 | 13 | 470 | 530 |
| 207 | 4 | — | — | — |
| 208 | 5 | 15 | 370 | 510 |

As can be seen in Table V, all the patterns have different emission wavelengths. The painting is authenticated as described in the previous examples, by irradiating with the appropriate excitation wavelengths, and comparing with an authentication sequence. In this case, overlapping patterns 205 and 206 are excited by the same wavelength, and will therefore emit light at both 570 nm and 530 nm. Again, the order of irradiation is irrelevant, as is the order of the patterns in the authentication sequence (as long as the correlation with the examined sequence is known). This example illustrates a sequence of patterns 203-208 that includes a series (205, 206).

As noted above, methods similar to the above-described authentication methods may be used to identify an article, for example, to tell which bank provided the banknote 2 of FIG. 1. According to such an identification method, a plurality of authentication sequences are provided, each associated with a certain bank, and light is irradiated on the banknote according to each of the provided authentication sequences. As shown in Tables II and IV, it may also be arranged that light is irradiated only once, (because all authentication sequences have the same excitation wavelengths and in the same order) and the emitted wavelengths are compared to the sequence of emission wavelengths of each of the authentication sequences. When an authentication sequence that matches Table II is found, the banknote 2 is identified as being provided by the bank corresponding to this authentication sequence. If no such authentication sequence is found, it may be concluded that the banknote 2 is not genuine.

The members of the authentication and unique sequences according to the present invention may be characterized by their excitation and emission wavelengths, as exemplified above, and also by further characteristics, such as the intensity of the emitted light, which may be manipulated by the concentration of the photoluminescent material applied to the article to produce an invisible photoluminescent pattern. Another possibility is to use materials with different time delays (between the end of excitation and the end of emission), such that each pattern is characterized not only by its excitation wavelength and emission wavelength but also by its emission intensity and time delay.

An authentication sequence consisting of only photoluminescent patterns (with no non-luminescent pattern, like, for example, that of Table III) may thus be useful for the identification of km different articles, with k^{m} representing the number of invisible patterns marked on the article (i.e. the number of members in the authentication sequence, which is four in FIG. 2) and k represents the number of mutually different excitation-emission wavelength-pairs used in the marking system.

If each pattern is marked by a material that is excitable only by a single wavelength to emit in only a single wavelength, and if the materials do not differ in density, then k is the number of mutually different photoluminescent materials used for marking.

If non-photoluminescent patterns are allowed, the number of articles that may be identified, namely the number of combinations of excitation wavelengths, emission wavelengths, and non-photoluminescent patterns is larger than when non-photoluminescent patterns are not included in the unique sequence.

The marking method and the authentication method of the invention may be used even with an authentication series wherein m=2 and k=2. However, this leaves room for only four possible markings. This may be enough if the method is used mainly for identifying four or less articles, and it is believed that the potential forgers have no idea regarding the basic principles of the authentication method used, so it is not the richness of possibilities that protects from forgery but the very use of the invented methods.

To allow identification of a larger number of articles it may be convenient to use k=9 (to represent, together with non-photoluminescent pattern, the decimal system), k=25 (to represent alphabetic data) or k=35 (to represent alphanumeric data). In most practical cases m will be between 4 and 8, although the invention is in no way limited to these figures. In case m=8 and k=26 the number of possibilities is about 2*10¹¹.

Typically, the markings are marked on the article by printing. Any printing method may be suitable for this. Some examples are ink jet printing, laser toner printing, thermal printing, thermal transfer printing, impression printing, offset printing, flexo printing, screen printing, gravure printing and intaglio printing. Apart from printing the markings could be marked by incorporation of the photoluminescent materials into a substrate, such as paper, textile, plastics, etc.

1. A method for marking an article to allow its identification or authentication comprising applying to the article a unique sequence of patterns, including invisible photoluminescent patterns, wherein each pattern has a position in the sequence, and each invisible photoluminescent pattern is characterized by at least one excitation wavelength, at least one emission wavelength, and at least one time delay, such that upon irradiation with light of the excitation wavelength said pattern emits light of the emission wavelength, and upon stoppage of said irradiation said pattern continues to emit light for a time delay, and at least two of said photoluminescent patterns have mutually different excitation wavelengths and/or time delays.

2. A method according to claim 1 wherein at least two of said photoluminescent patterns have mutually different excitation wavelengths.

3. A method according to claim 1 wherein at least two of said photoluminescent patterns have mutually different time delays.

4. A method according to any one of claims 1 to 3 wherein said invisible photoluminescent patterns are not detectable to the human eye under any lighting conditions.

5. A method according to claim 4 wherein said invisible photoluminescent patterns have both excitation and emission wavelengths out of the visible range.

6. A method according to claim 4 wherein the absorption of visible light by said invisible patterns is the same as that of their background and the emission wavelengths of said invisible photoluminescent patterns are out of the visible range.

7. A method according to claim 1 wherein said patterns are of simple geometric shapes.

8. A method according to claim 5 wherein said patterns have shapes selected from squares, rectangles, triangles, and circles.

9. A method according to claim 6 wherein said patterns are rectangular strips.

10. A method according to any one of the preceding claim, wherein said unique sequence of patterns include non-luminescent patterns.

11. A method according to any one of the preceding claims wherein said patterns are adjacent to each other to compose a string.

12. A method according to any one of the preceding claims, wherein at least two of said patterns have overlapping positions.

13. A method according to any one of the preceding claims, wherein all said patterns have overlapping positions.

14. A method according to any one of the preceding claims wherein said invisible photoluminescent patterns are applied to the article by printing.

15. A method according to claim 14 wherein said printing is selected from ink jet printing, laser toner printing, thermal printing, thermal transfer printing, impression printing, offset printing, flexo printing, screen printing, gravure printing, and intaglio printing.

16. An authentication method, for authenticating an article having a unique sequence of patterns, including invisible photoluminescent patterns, wherein each pattern has a position in the sequence, and each invisible photoluminescent pattern is characterized by at least one excitation wavelength, at least one emission wavelength, and at least one time delay, such that upon irradiation with light of the excitation wavelength said pattern emits light of the emission wavelength, said emission continues for a time delay after stoppage of said irradiation, and at least two of said photoluminescent patterns have mutually different excitation wavelengths and/or time delays, the method comprising:
(i) providing an authentication sequence including positions in the sequence that are each characterized by an excitation wavelength, an emission wavelength, and a time delay, at least two of said excitation wavelengths and/or time delays being mutually different;
(ii) irradiating each of the invisible photoluminescent patterns composing the unique sequence of patterns marked on said article with a light beam having a wavelength identical to the excitation wavelength characterizing a position in the authentication sequence that corresponds to the position of the irradiated invisible photoluminescent pattern in the unique sequence;
(iii) detecting wavelengths of light emitted by each of said invisible photoluminescent patterns to obtain a sequence of emission wavelengths; and
(iv) comparing the sequence of emission wavelengths obtained in (iii) with the emission wavelengths of the authentication sequence provided in (i) to determine if the article is authentic or not.

17. A method according to claim 16 wherein in (iv) it is determined that the article is authentic if the compared sequences are identical and not authentic otherwise.

18. A method for identifying an identity of an article having a unique sequence of patterns, including invisible photoluminescent patterns, wherein each pattern has a position in the sequence, and each invisible photoluminescent pattern is characterized by at least one excitation wavelength and at least one emission wavelength, such that upon irradiation with light of the excitation wavelength said pattern emits light of the emission wavelength, and at least two of said photoluminescent patterns have mutually different excitation wavelengths, the method comprising:
(i) providing a plurality of authentication sequences, each associated with a certain article identity, and each including positions in the sequence that are each characterized by an excitation wavelength and an emission wavelength, at least two of said excitation wavelengths being mutually different;
(ii) repeating (1), (2), and (3) as recited below one or more times, each time with another of the authentication sequences provided in (i) until said authentication sequence is found to correspond to the unique sequence of the article, and
(iii) identifying the article as having the identity associated with the authentication sequence that was found to correspond to the unique sequence of the article; wherein (1), (2), and (3) referred above are as follows:
(1) irradiating each of the invisible photoluminescent patterns composing the unique sequence marked on said article with a light beam having a wavelength identical to the excitation wavelength characterizing a position in the authentication sequence that corresponds to the position of the irradiated invisible photoluminescent pattern in the unique sequence;
(2) detecting wavelengths of light emitted by each of said invisible photoluminescent patterns to obtain a sequence of emission wavelengths; and
(3) comparing a sequence of emission wavelengths obtained in (i) with the emission wavelengths of the authentication sequence provided in (2).

19. An article having a unique sequence of patterns, including invisible photoluminescent patterns, wherein each pattern has a position in the sequence, and each invisible photoluminescent pattern is characterized by an excitation wavelength and an emission wavelength, such that upon irradiation with light of the excitation wavelength said pattern emits light of the emission wavelength, and at least two of said photoluminescent patterns have mutually different excitation wavelengths.

20. An article according to claim 16 wherein said invisible photoluminescent patterns are not detectable to the human eye under any lighting conditions.

21. An article according to claim 19 wherein said invisible photoluminescent patterns have both excitation and emission wavelengths out of the visible range.

22. An article according to claim 19 wherein the absorption of visible light by said invisible patterns is the same as that of their background, and the emission wavelengths of said invisible photoluminescent patterns are out of the visible range.

23. An article according to claim 17 wherein said patterns are of simple geometric shapes.

24. An article according to claim 23 wherein said patterns have shapes selected from squares, rectangles, triangles, and circles.

25. An article according to claim 24 wherein said patterns are rectangular strips.

26. An article according to claim 17, wherein said unique sequence of patterns include non-luminescent patterns.

27. An article according to claim 17 wherein said patterns are adjacent to each other to compose a string.

28. An article according to claim 17, wherein at least two of said patterns may have overlapping positions.

29. An article according to claim 17, wherein all of said patterns have overlapping positions.

30. An article according to claim 17 wherein said invisible photoluminescent patterns are applied to the article by printing.

31. A method for the preparation of an article according to claim 31 wherein said printing is selected from ink jet printing, laser toner printing, thermal printing, thermal transfer printing, impression printing, offset printing, flexo printing, screen printing, gravure printing, and intaglio printing.
